(19) United States
(12) Patent Application Publication
(10) Pub. No.: US 2015/0113396 A1
(43) Pub. Date: Apr. 23, 2015

(54) CURVED SHADOWS IN VISUAL REPRESENTATIONS

(71) Applicant: APPLE INC., Cupertino, CA (US)

(72) Inventors: William J. Thimbleby, Sunnyvale, CA (US); Jennifer Pon Chan, Pittsburgh, PA (US)

(73) Assignee: APPLE INC., Cupertino, CA (US)

(21) Appl. No.: 14/057,632

(22) Filed: Oct. 18, 2013

(51) Int. Cl. G06T 11/00; G06T 11/60; G06F 3/0484

(52) U.S. Cl. CPC G06T 11/001; G06F 3/04847; G06T 11/60; G06F 3/04845; G06T 2200/24; G06T 2210/62
USPC 715/275

(57) ABSTRACT

Embodiments of the present disclosure relate to a method for generating a simulated shadow for a digital object on a virtual curved surface in a digital canvas. A base image is generated by removing color from the digital object. An initial shadow image is generated by identifying the virtual curved surface on the digital canvas and projecting the base image onto the virtual curved surface. A plurality of blurred images is generated by blurring the initial shadow image to different percentages of blur for each of the plurality of blurred images. A mathematical function is applied for generating the simulated shadow on the virtual curved surface, wherein the mathematical function interpolates between the initial shadow image and the plurality of blurred images at different points on the virtual curved surface.

### BACKGROUND

The present disclosure relates generally to the enhancement of visual representations using a process-implemented algorithm. In particular, the disclosure relates to creating shadows on a defined curve.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Various computer programs, such as presentation applications, word processing applications, and spreadsheet applications, include functionality that allows a user to add objects to a slide or other work product generated by the program. Further application functionality typically allows the user to enhance the visual effects associated with such objects. For example, computer-implemented presentation applications may allow a user to add an object (such as an image) to a slide and to modify the object by applying a shadow effect or a border, changing the image's opacity, and so forth. Applying a shadow effect to an image can help create an impression of perspective and depth, which may provide for a richer and more realistic looking presentation. Conversely, in the absence of such effects, an image may appear to be merely floating in a virtual workspace or as part of a two-dimensional tile, with no other spatial context. In other words, generating a shadow for an object may partially define a location or provide context for the object relative to other objects or portions of the work space, as opposed to having the object float in empty space. As such, there is a need for enhanced methods to render accurate and efficient shadows of digital objects.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Disclosed embodiments provide techniques for developing a curved shadow of a digital object within a presentation application and displaying the curved shadow. In certain embodiments, the presentation application may generate various curved, blurred images originating from a colorless version of the initial digital object projected onto the curve or curved surface. The presentation application may include a mathematical formula that interpolates between the curved, blurred images at different points on the virtual curved surface to generate a curved shadow that exhibits varying and accurate blurriness representative of the distance between the curved shadow and the virtual curved surface at each respective point. Further, a user may define an offset between the digital object and the virtual curved surface such that the presentation application generates a curved shadow representative of the distance between the digital object and the virtual curved surface (e.g., the curved shadow may appear blurrier with a greater offset). Other user controllable features may include opacity control (to vary transparency of the curved shadow), shadow perspective control (to vary a location for a virtual light source generating the curved shadow), and curve control (to vary curvature of the virtual curved surface).

### BRIEF DESCRIPTION OF THE DRAWINGS

Various aspects of this disclosure may be better understood upon reading the following detailed description and upon reference to the drawings in which:

FIG. 1 is a block diagram of an electronic device that may use the techniques disclosed herein, in accordance with aspects of the present disclosure;

FIG. 2 is a front view of a handheld device, such as an iPhone® by Apple Inc., representing an example of the electronic device of FIG. 1;

FIG. 3 is a front view of a tablet device, such as an iPad® by Apple Inc., representing an example of the electronic device of FIG. 1;

FIG. 4 is a perspective view of a notebook computer, such as a MacBook Pro® by Apple Inc., representing an example of the electronic device of FIG. 1;

FIG. 5 illustrates an edit mode screen of a presentation application in accordance with aspects of the present disclosure;

FIG. 6 is a flow diagram illustrating a method for generating a curved shadow using a suitable computer application, in accordance with aspects of the present disclosure;

FIG. 7 is a schematic illustration of steps of the method of FIG. 6 and a result of the steps;

FIG. 8 is another schematic illustration of steps of the method of FIG. 6 and a result of the steps;

FIG. 9 is another schematic illustration of steps of the method of FIG. 6 and a result of the steps;

FIG. 10 depicts curved shadows generated by steps of the method of FIG. 6;

FIG. 11 depicts another view of curved shadows generated by steps of the method of FIG. 6; and

FIG. 12 is an illustration of examples of curved shadows generated for different objects by the method of FIG. 6.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As discussed herein, certain types of computer applications (such as word processing programs, spreadsheet programs, or presentation programs) may allow a user to add images to a document or presentation. These computer applications may also allow the user to apply effects to the images in order to enhance or alter the image or the impression generated by the image. Images to which such effects may be applied include, but are not limited to text objects (e.g., characters and character strings), shapes, pictures, graphics, and so forth. The modifications that may be made to such images are numerous and include applying a shadow effect, as discussed herein. More specifically, a curved shadow effect may be applied to create the impression of curvature with respect to the object or to the virtual surface on which the shadow is projected. For example, curved shadows, as discussed herein, may be applied to an image to give the impression that the image is itself bowed inward or outward or is casting a shadow on a curved surface. As discussed herein, present embodiments may address various approaches by which the creation of curved shadows for an image results in object specific curved shadows in a computationally efficient manner.

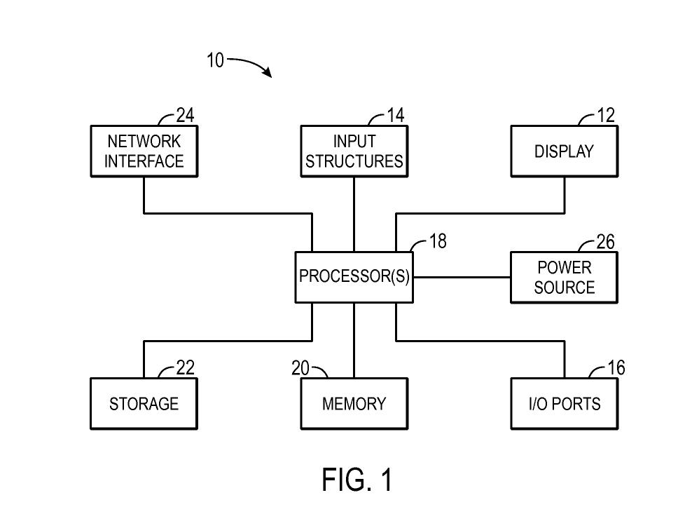

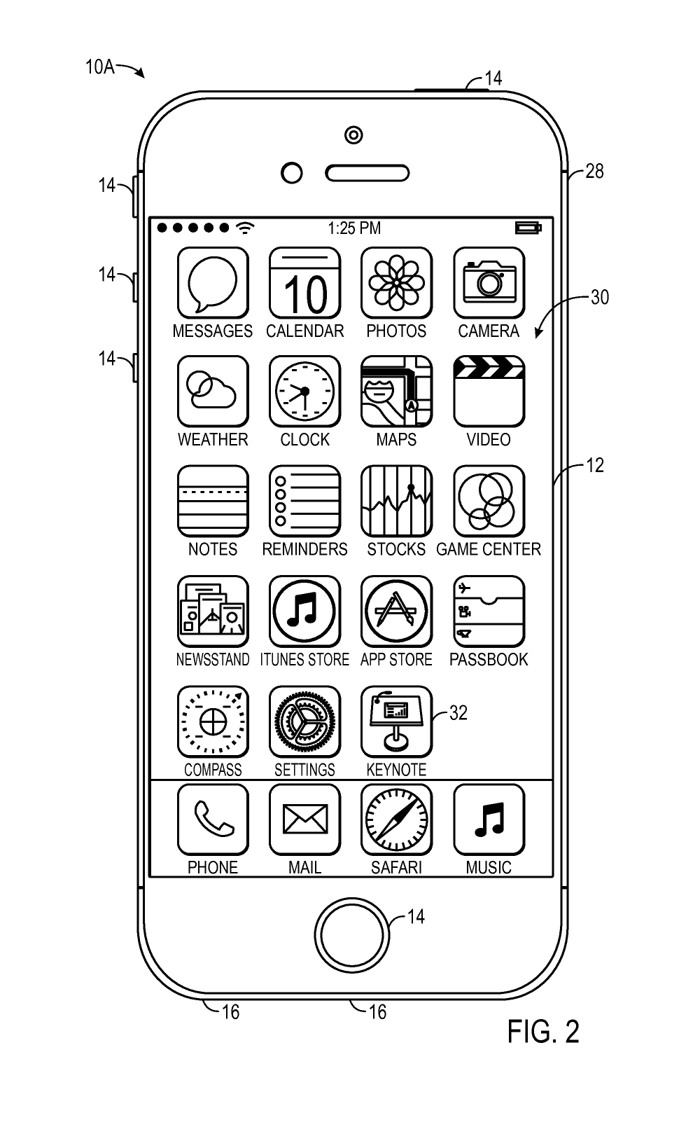

With the preceding discussion in mind, a variety of suitable electronic devices may be used to create or display curved shadows as discussed herein. FIG. 1, for example, is a block diagram depicting various components that may be present in a suitable electronic device 10. FIGS. 2, 3, and 4 illustrate example embodiments of the electronic device 10, depicting a handheld electronic device, a tablet computing device, and a notebook computer, respectively.

Turning first to FIG. 1, the electronic device 10 may include, among other things, a display 12, input structures 14, input/output (I/O) ports 16, one or more processor(s) 18, memory 20, nonvolatile storage 22, a network interface 24, and a power source 26. The various functional blocks shown in FIG. 1 may include hardware elements (including circuitry), software elements (including computer code stored on a non-transitory computer-readable medium) or a combination of both hardware and software elements. It should be noted that FIG. 1 is merely one example of a particular implementation and is intended to illustrate the types of components that may be present in the electronic device 10. Indeed, the various depicted components (e.g., the processor(s) 18) may be separate components, components of a single contained module (e.g., a system-on-a-chip device), or may be incorporated wholly or partially within any of the other elements within the electronic device 10. The components depicted in FIG. 1 may be embodied wholly or in part as machine-readable instructions (e.g., software or firmware), hardware, or any combination thereof.

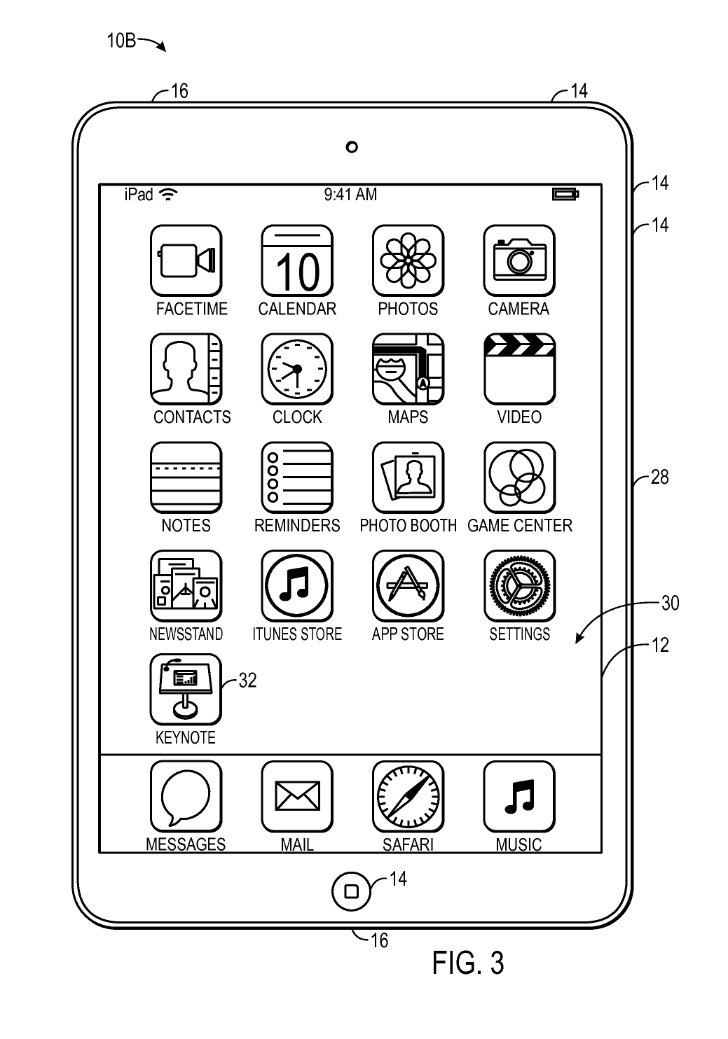

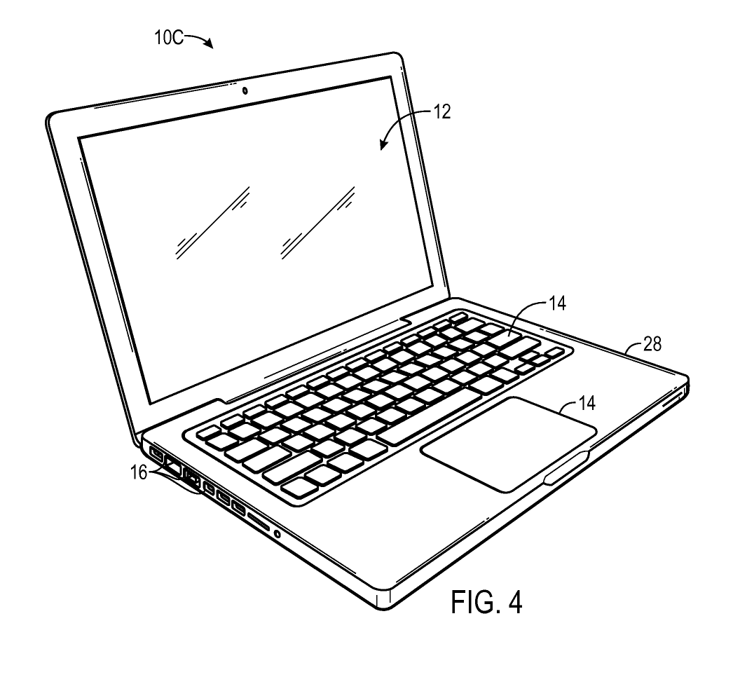

By way of example, the electronic device 10 may represent a block diagram of the handheld device depicted in FIG. 2, the tablet computing device depicted in FIG. 3, the notebook computer depicted in FIG. 4, or similar devices, such as desktop computers, televisions, and so forth. In the electronic device 10 of FIG. 1, the display 12 may be any suitable electronic display used to display image data (e.g., a liquid crystal display (LCD) or an organic light emitting diode (OLED) display). In some examples, the display 12 may represent one of the input structures 14, enabling users to interact with a user interface of the electronic device 10. In some embodiments, the electronic display 12 may be a MultiTouch™ display that can detect multiple touches at once. Other input structures 14 of the electronic device 10 may include buttons, keyboards, mice, trackpads, and the like. The I/O ports 16 may enable electronic device 10 to interface with various other electronic devices.

The processor(s) 18 and/or other data processing circuitry may execute instructions and/or operate on data stored in the memory 20 and/or nonvolatile storage 22. The memory 20 and the nonvolatile storage 22 may be any suitable articles of manufacture that include tangible, non-transitory computer-readable media to store the instructions or data, such as random-access memory, read-only memory, rewritable flash memory, hard drives, and optical discs. By way of example, a computer program product containing the instructions may include an operating system (e.g., OS X® or iOS by Apple Inc.) or an application program (e.g., Keynote® by Apple Inc.). In some embodiments, as will be described in detail below, the application program may provide instructions to the processor(s) 18 to execute code that creates or displays a curved shadow for a selected image that is displayed by the application program.

The network interface 24 may include, for example, one or more interfaces for a personal area network (PAN), such as a Bluetooth network, for a local area network (LAN), such as an 802.11x Wi-Fi network, and/or for a wide area network (WAN), such as a 4G or LTE cellular network. The power source 26 of the electronic device 10 may be any suitable source of energy, such as a rechargeable lithium polymer (Li-poly) battery and/or an alternating current (AC) power converter.

As mentioned above, the electronic device 10 may take the form of a computer or other type of electronic device. Such computers may include computers that are generally portable (such as laptop, notebook, and tablet computers) as well as computers that are generally used in one place (such as conventional desktop computers, workstations and/or servers). FIG. 2 depicts a front view of a handheld device 10A, which represents one embodiment of the electronic device 10. The handheld device 10A may represent, for example, a portable phone, a media player, a personal data organizer, a handheld game platform, or any combination of such devices. By way of example, the handheld device 10A may be a model of an iPod® or iPhone® available from Apple Inc. of Cupertino, Calif.

The handheld device 10A may include an enclosure 28 to protect interior components from physical damage and to shield them from electromagnetic interference. The enclosure 28 may surround the display 12, which may display a graphical user interface (GUI) 30 having an array of icons 32. By way of example, one of the icons 32 may launch a presentation application program (e.g., Keynote® by Apple Inc.). User input structures 14, in combination with the display 12, may allow a user to control the handheld device 10A. For example, the input structures 14 may activate or deactivate the handheld device 10A, navigate a user interface to a home screen, navigate a user interface to a user-configurable application screen, activate a voice-recognition feature, provide volume control, and toggle between vibrate and ring modes. Touch screen features of the display 12 of the handheld device 10A may provide a simplified approach to controlling the presentation application program. The handheld device 10A may include I/O ports 16 that open through the enclosure 28. These I/O ports 16 may include, for example, an audio jack and/or a Lightning® port from Apple Inc. to connect to external devices. The electronic device 10 may also be a tablet device 10B, as illustrated in FIG. 3. For example, the tablet device 10B may be a model of an iPad® available from Apple Inc.

In certain embodiments, the electronic device 10 may take the form of a computer, such as a model of a MacBook®, MacBook® Pro, MacBook Air®, iMac®, Mac® mini, or Mac Pro® available from Apple Inc. By way of example, the electronic device 10, taking the form of a notebook computer 10C, is illustrated in FIG. 4 in accordance with one embodiment of the present disclosure. The depicted computer 10C may include a display 12, input structures 14, I/O ports 16, and a housing 28. In one embodiment, the input structures 14 (e.g., a keyboard and/or touchpad) may be used to interact with the computer 10C, such as to start, control, or operate a GUI or applications (e.g., Keynote® by Apple Inc.) running on the computer 10C.

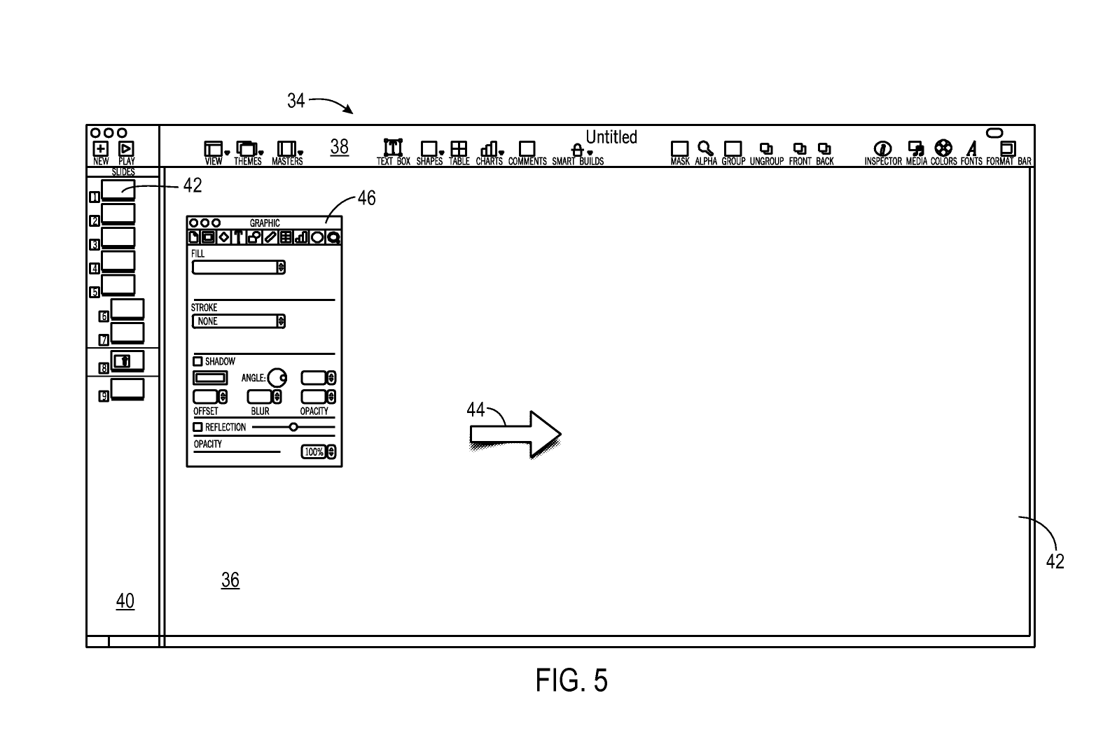

With the preceding discussion of example systems in mind, a variety of computer program products, such as applications or operating systems, may use the techniques discussed below to enhance the user experience on the electronic device 10. Indeed, any suitable computer program product that displays and/or allows editing of shapes or images may employ the techniques discussed below to provide curved shadows for display with such shapes or images. For instance, a suitable electronic device 10 may run a presentation application 34 (e.g., Keynote® from Apple Inc.), an example screen of which is shown in FIG. 5.

The presentation application 34 shown in FIG. 5 may provide multiple modes of operation, such as an edit mode and a presentation mode. In FIG. 5, the presentation application 34 is shown in the edit mode. In the edit mode, the presentation application 34 may provide a convenient and user-friendly interface for a user to add, edit, remove, or otherwise modify the slides of a slide show. To this end, the presentation application 34 may include three panes: a canvas 36, a toolbar 38, and a slide organizer 40. The canvas 36 may display a currently selected slide 42 from among the slide organizer 40. A user may add content to the canvas 36 using tool selections from the toolbar 38. Among other things, this content may include objects 44 (or object images) such as text boxes, images, shapes, and/or video objects. When in the edit mode, the user may add or remove objects and/or may assign actions and/or effects to one or more of the objects 44 associated with a slide of the slide show. For example, as will be discussed in detail below, one such effect that the user may assign to the objects is a curved shadow, as discussed herein. In the presentation mode, the user may display a created slide or a sequence of slides in a format suitable for audience viewing. In some embodiments, the presentation application 34 may provide a full-screen presentation of the slides in the presentation mode, including any animations, transitions, or other properties or effects defined for each object within the slides.

As will be appreciated, though a presentation application is described by way of example to provide a useful context for understanding the present discussion, other computer-implemented applications may also benefit from these approaches. For example, a spreadsheet program or word processing application, either of which may allow a user to display objects in a work product, may also benefit from the present discussion regarding curved shadows and may be similarly configured to display objects with curved shadows as part of the spreadsheets or word processing documents generated using those programs.

As used herein, the term “object” refers to any individually editable component on a canvas (e.g., the canvas 36 of the presentation application 34) or other application work space. That is, content that can be added to a slide and/or be altered or edited on the slide may constitute an object. For example, a graphic, such as an image, photo, line drawing, clip art, chart, or table, that may be provided on a slide or other application work space may constitute an object. In addition, a character or string of characters may constitute an object. Likewise, an embedded video clip may also constitute an object that is a component of a slide. Applying changes or alterations of an object, such as to change its location, size, orientation, appearance or to change its content, may be understood to be changing a property of the object. Therefore, in certain embodiments, shapes characters and/or character strings (alphabetic, numeric, and/or symbolic), image files (.jpg, .bmp, .gif, .tif, .png, .cgm, .svg, .pdf, .wmf, and so forth), video files (.avi, .mov, .mp4, .mpg, .qt, .rm, .swf, .wmv, and so forth) and other multimedia files or other files in general may constitute “objects” as used herein. In certain graphics processing contexts, the term “object” may be used interchangeably with terms such as “bitmap” or “texture.”

As used herein, a “slide” should be understood to refer to a discrete unit of an ordered or sequential presentation. Such a slide, therefore, may be understood to function as a container for a set of objects (as discussed below) that together convey information about a concept. For example, a slide may contain or include different types of multimedia objects (e.g., text, numbers, images, videos, charts, graphs, and/or audio, and so forth) that explain or describe a concept to which the slide is directed and which may be handled or manipulated as a unit due to their being associated with or contained on the slide unit As will be appreciated, in contexts other than presentation applications, the work space on which an object may be placed and/or manipulated may be a spreadsheet, a document, and so forth.

The order or sequence of the slides in a presentation or slideshow is typically relevant in that the information on the slides (which may include both alphanumeric (text and numbers) and graphical components) is meant to be presented in order or sequence and may build upon itself, such that the information on later slides is understandable in the context of information provided on preceding slides. That is, there is a narrative or explanatory flow associated with the ordering or sequence of the slides. As a result, if presented out of order, the information on the slides may be unintelligible or may otherwise fail to properly convey the information contained in the presentation. This should be understood to be in contrast to more simplistic or earlier usages of the term “slide” and “slideshow” where what was typically shown was not a series of multimedia slides containing sequentially ordered content, but projected photos or images which could typically be displayed in any order without loss of information or content.

As mentioned above, the depicted example screen shown in FIG. 5 includes three panes: a slide canvas 36, a toolbar 38, and a slide organizer 40 for creating and editing various aspects of a slide of a presentation. With these panes, a user may select a slide of a presentation, add and/or edit the contents of a slide, and animate or add effects related to the contents of a slide. It should be understood that the size of each pane is merely illustrative, and that the relative size of each pane may vary or be adjusted by a user.

The slide organizer 40 may display a representation of each slide of a presentation that is being generated or edited. The slide representations may take on a variety of forms, such as an outline of the text in the slide or a thumbnail image of the slide. The slide organizer 40 may allow the user to organize the slides prepared using the application. For example, the user may determine or manipulate an order in which the slides are presented by dragging a slide representation from one relative position to another. As illustrated in FIG. 5, the slide representations in the slide organizer 40 may be indented or otherwise visually set apart for further organizational clarity.

Selecting a slide representation in the slide organizer 40 may result in the presentation application 34 displaying the corresponding slide (e.g., slide 42) on the canvas 36. The selected slide 42 may include one or more suitable objects 44 such as, for example, text, images, graphics, video, or any other suitable object. A user may add or edit features or properties of the selected slide 42 when displayed on the slide canvas 36, or work space, such as to add a simulated shadow effect. For example, a user may edit settings or properties associated with the selected slide 42 (e.g., the slide background or template) on the canvas 36 or may edit the location, orientation, size, properties, and/or animation of objects (e.g., object 44) in the selected slide. One such edit the user may make is applying a simulated curved shadow effect to one or more of the objects 44. The user may select a different slide to be displayed for editing on slide canvas 36 by selecting a different slide representation from the slide organizer 40.

In the depicted implementation, a user may customize objects 44 associated with the slide 42 or the properties of the slide 42 using various tools provided by the presentation application 34 in association with the canvas 36. For example, the toolbar 38 may provide various icons that activate respective tools and/or functions that may be used in creating or editing the slide 42.

In some embodiments, the presentation application 34 may allow a control window 46 to be opened or displayed. The presentation application 34 may display the control window 46 automatically (e.g., based on the presentation application 34 context) or in response to a user instruction (e.g., in response to a user instruction to display options related to one or more selected objects). Further, the control window 46 may open when a certain option is selected on the toolbar 38. The control window 46 may be moved, resized, and/or minimized/maximized independently of the panes 36, 38, and 40 (e.g., as an overlaid window). The control window 46 may provide one or more user input mechanisms of any suitable type, such as drop down menus, radio buttons, sliders, and so forth. The options available from control window 46 may vary based on a tool selected in toolbar 38 or by a type of object(s) 44 selected on the slide 42. For example, the control window 46 may provide different respective options if a table, video, graphic, or text is selected on the slide 42 or if no object 44 is selected. It should be understood that although only one control window 46 is shown in FIG. 5, the presentation application 34 may include any suitable number of control windows 46.

The control window 46 may be also be used to add an effect to one or more objects 44 in the presentation application 34. The effect may be a static or dynamic effect. For example, in one embodiment, the control window 46 may be used to assist in defining and generating a shadow for an object 44, as discussed herein. In this embodiment, the control window 46 may include a number of sliders (or other controls such as toggles, radio buttons, virtual buttons, character entry fields, and so forth) that a user may interact with to set or adjust aspects of the shadow effect to be applied to the object 44. For example, sliders in the control window 46 may be controlled by the user to define a type of shadow (e.g., a curved shadow 48), an offset for the shadow, a perspective of the shadow (e.g., a projection or casting angle associated with the shadow effect), a curvature to the shadow, or some other characteristic of the shadow. The shadow may be generated such that it is a part of the object 44, or it may be generated such that the shadow is itself a separate object handled and displayed on the slide.

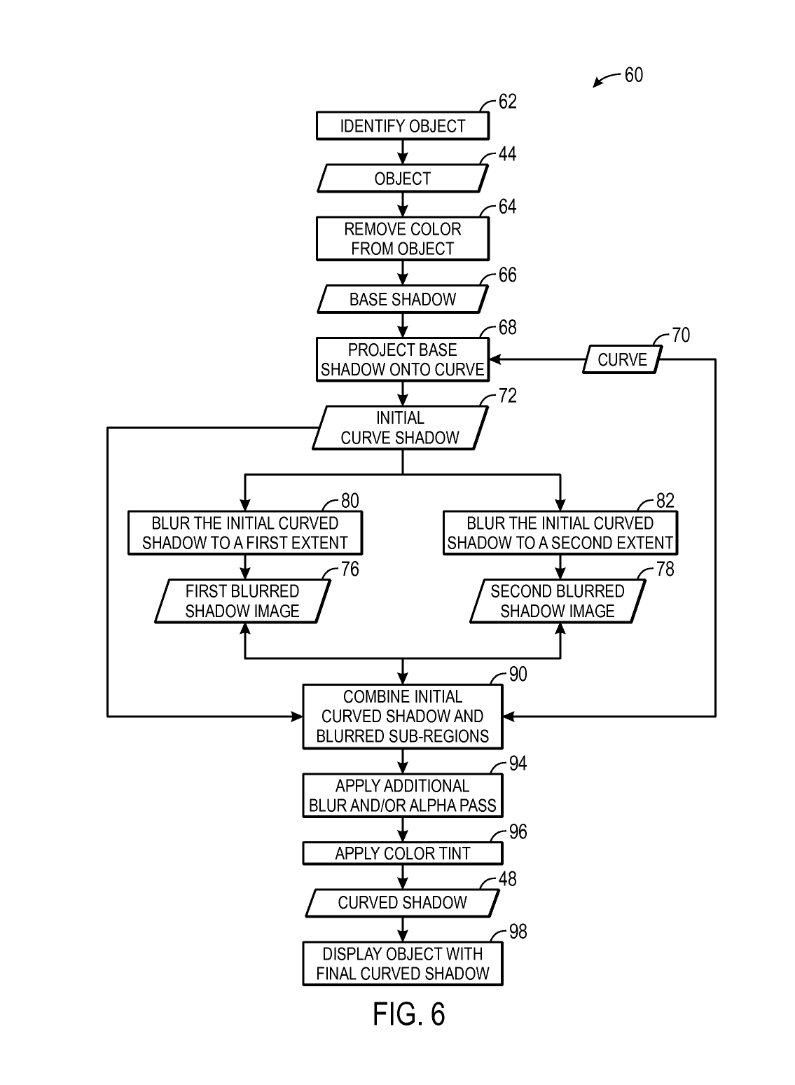

With the preceding comments in mind, a flow diagram 60 is depicted in FIG. 6 illustrating a process for creating a curved shadow 48 (e.g., a shadow having the appearance of being projected or cast on a curved surface) of an object 44 in accordance with one approach. In the illustrated embodiment, the object 44 is identified, as shown in block 62. For example, in a computer program, a presentation application, a spreadsheet program, and so forth, a document or slide may be generated on which an object 44 is displayed, and routines executing within the application or program may identify the object 44 as an object that can be manipulated and to which a shadow effect can be applied.

In response to an instruction to apply such a shadow effect, color is removed from the object 44, as shown in block 64, to generate a base shadow image 66. There are several ways to remove color from the object 44. For example, in one embodiment, the object 44 may be passed through an alpha shader or an algorithm that converts each pixel's RGB scale to (0,0,0) or (1,1,1), such that the object 44 is made into a black and white base shadow image 66. Further, the alpha shader and/or algorithm may adjust the alpha value for manipulating opacity of each pixel of the base shadow image 66 or portions of the base shadow image 66. It should be noted that there are other suitable techniques for removing color from a digital image to generate the base shadow image 66, and that the above referenced technique is provided merely as one example of such techniques. The base shadow image 66 is projected (block 68) onto a defined curve 70 (or defined curved surface) to generate an initial curved shadow 72.

In one embodiment, the initial curved shadow 72 may be modified to enhance the appearance of the image. For example, in one embodiment, all or part of the initial curved shadow 72 may be blurred to different extents. In this manner, a number of differently blurred curved shadow images may be generated (blocks 80 and 82) (e.g., a first blurred shadow image 76 that is blurred to one extent, a second blurred shadow image 78 that is blurred to a different extent, and so forth). For example, in one embodiment, the first blurred shadow image 76 may be blurred twice as much as the second blurred shadow image 78. In one such implementation, therefore, the first blurred shadow image 76 may be referred to as a “fully blurred” or “blurred” curved shadow image, while the second blurred shadow image 78 may be referred to as a “half blurred” or “partially blurred” curved shadow image. It should be noted that “fully blurred” may be arbitrary, or it may represent a full blur to the extent the program allows or a user defines. In the present embodiment, “fully blurred” is a relative term in order to clarify that the fully blurred shadow image 76 is more blurred (e.g., twice as blurred) as the partially blurred (e.g., half-blurred) shadow image 78.

In one implementation, to generate the curved shadow 48 of the object 44, a mathematical formula is applied (block 90) to interpolate between the differently blurred shadow images 76, 78 and the initial curved shadow 72 at different points on, or regions of, a defined curve 70 (i.e., the curve on which the base shadow image 66 was projected). The defined curve 70 may be user-defined or it may be calculated by, or a default of, the computer program or presentation application being used. Further, the mathematical formula may be parabolic, quadratic, some other suitable mathematical function representative of a curvature, and/or subject to some other algorithm representative of a curvature. In one embodiment, the formula interpolates between the initial curved shadow 72, which is essentially a black and white or gray scale version of the object 44, the fully blurred shadow image 76, and the partially blurred shadow image 78.

The mathematical formula may be used to interpolate between the images to determine the appropriate blurriness of the curved shadow 48 at a particular point on the defined curve 70. The interpolation may be based on parameters of the point on, or region of, the defined curve 70 in question. For example, a point on the defined curve 70 that is intended to appear to be close to or in contact with the object 44 may be heavily weighted toward the initial curved shadow image 72, i.e., the non-blurred shadow image, associated with the location of the point to generate a dark, relatively defined shadow, thereby highlighting the perceived proximity of object 44 and the virtual surface on which the final curved shadow 48 is projected. Conversely, a point on the defined curve 70 that is intended to have the appearance of being far from the object 44 or not in contact with the object 44 may be weighted toward the fully blurred shadow image 76 to generate a relatively blurry final curved shadow 48, to create the appearance of separation between the object 44 and the virtual surface on which the final curved shadow image 48 is projected. At intermediary points or regions, the mathematical formula may interpolate or sample from more than one of the shadow images 72, 76, 78 to achieve the desired degree of blur corresponding to the desired appearance of separation between the object 44 and the point or region on the virtual surface on which the final curved shadow 48 is projected.

It should be noted that the blurring process represented in blocks 80 and 82 may be performed to generate more than two differently blurred shadow images. For example, three, four, or more differently blurred shadow images may be generated instead, each exhibiting a different degree of blur (e.g., fully blurred, three quarter blurred, half blurred, and quarter blurred images). In such implementations, the mathematical formula may have more than three images to interpolate between. This may produce a more accurate version of the curved shadow 48, but it may also increase computing time and necessary computing power. Furthermore, in one embodiment, the blur percentage of each blurred image may not be evenly distributed as discussed with respect to previous embodiments, i.e., the blur effect may be a continuous function as opposed to a uniform function. In such an embodiment, the relative blur percentage of each blurred image may be passed through the mathematical formula such that the mathematical formula can properly interpolate between appropriate images in determining an output for the curved shadow 48.

In some embodiments, the curved shadow 48 generated from and output by the previously discussed algorithm may be further modified or enhanced. For example, additional blur or passes by an alpha filter may be applied (block 94) based on a defined offset. The defined offset may represent a distance or separation between the object 44 and the defined curve 70, i.e., the virtual surface on which the shadow is projected. The greater the defined offset, the more blurred or dispersed the curved shadow 48 may appear. Further, the defined offset may be a default of, or it may be calculated by, the computer program or presentation application, or it may be user-defined. The curved shadow 48 may also be color tinted by a color tinting step (block 96). The color tint of the curved shadow 48 may coordinate with the object 44 (e.g., a color similar to or determined by the color of the object 44), or it may be some other color chosen by the computer program, presentation application, or user. Once the curved shadow 48 is in its final form, it may be displayed (block 98) in conjunction with the object 44, such as on a slide of a slideshow presentation or on another work space or canvas defined for a computer application implementing the present curved shadow approach.

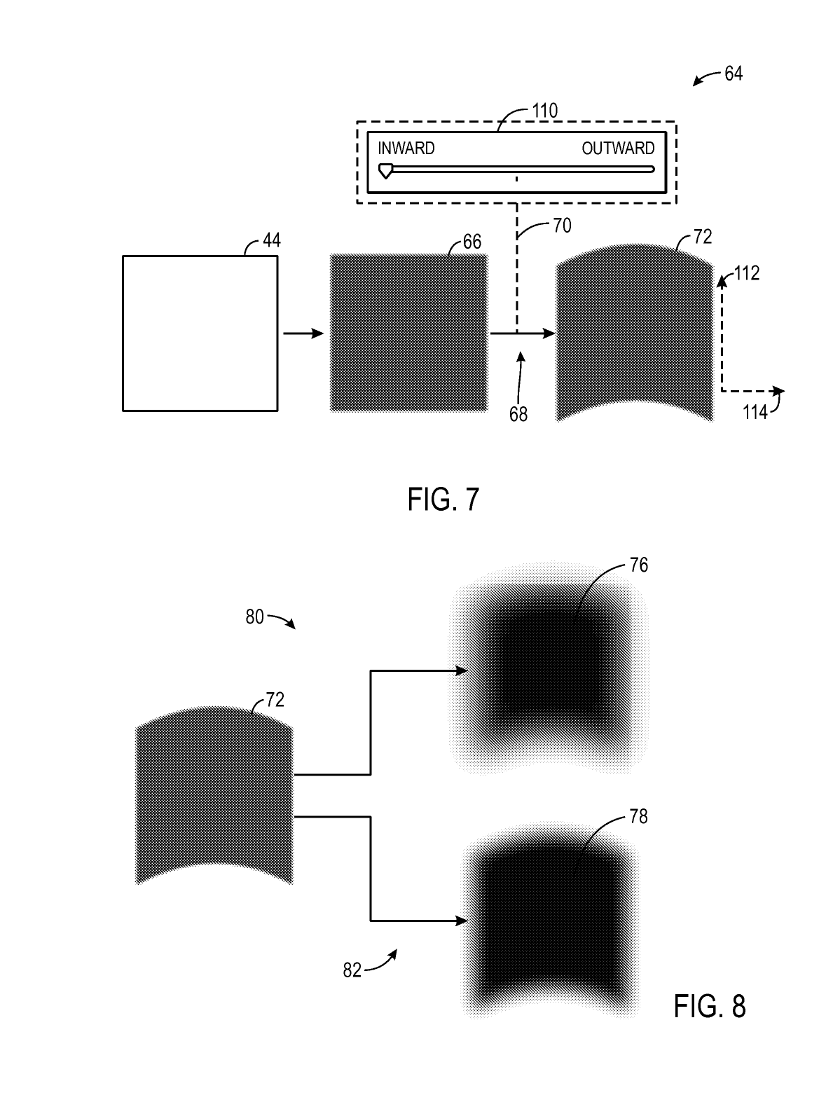

The preceding figure and discussion provides a general scope of an algorithm for generating curved shadows, as discussed herein. The following figures and discussion illustrate examples of certain of the described steps. Turning now to FIG. 7, an embodiment of the steps 64, 68 to generate an initial shadow 66 by removing color from the object 44 and to project the base shadow image 66 on the defined curve 70 is illustrated. As previously discussed, color may be removed from the object 44 via an alpha shader or some other process to generate the base shadow image 66. The base shadow image 66 is projected on the defined curve 70 to generate the initial curved shadow image 72 used in subsequent processes. The defined curve 70 may be a default of the computer or presentation application, or it may be user defined. For example, the user may alter the defined curve 70 via a curve control slider 110, which may be a part of the previously discussed control window 46. The curve control slider 110 may be used to set or adjust the curvature of the defined curve 70 as inward or outward (i.e., warped toward direction 112 or away from direction 112, respectively). Further, the curve control slider 110 may be used to define the extent or magnitude to which the defined curve 70 is curved inward or outward. Further still, in another embodiment, the curve control slider 110 or control window 46 may provide an option to change the orientation or perspective of the defined curve. For example, the curve control slider 110 may allow the user to manipulate the defined curve 70 such that the base shadow image 66 is warped with respect to direction 114, or with respect to a direction perpendicular to direction 114, when projected onto the defined curve 70. In other words, an option on the curve control slider 110 or control window 46 may allow for the defined curve 70 to be in a substantially perpendicular orientation, in another embodiment, to the orientation of the defined curve 70 illustrated in the present embodiment of FIG. 7.

In FIG. 8, the initial curved shadow image 72 is blurred to generate the differently blurred shadow images 76, 78, in accordance with an embodiment of the present disclosure. As previously discussed, the first blurred shadow image 76 is blurred (block 80) to a first degree, and the second blurred shadow image 78 is blurred (block 82) to a second degree, such as half that of the first blurred shadow image 76. For example, in one embodiment, the initial curved shadow image 72 may be blurred halfway to form the second, or partially blurred shadow image 78, and then blurred fully to form the first, or fully blurred shadow image 76. Alternatively, the blurring steps may be performed as separate and discrete operations. As noted above, the actual number of blur operations performed and blurred shadows generated may depend on factors such as desired accuracy of the curved shadow 48, desired computing time, and available computing power, with the present example of two such blurred shadows only describing one possibility. Further, the computer program or presentation application may be programmed to generate a set number of blurred images based on a default or a calculated available computing power, or the computer program or presentation application may have an option for the user to define how many blurred images to generate based on the relative importance of accuracy and computing speed to the user.

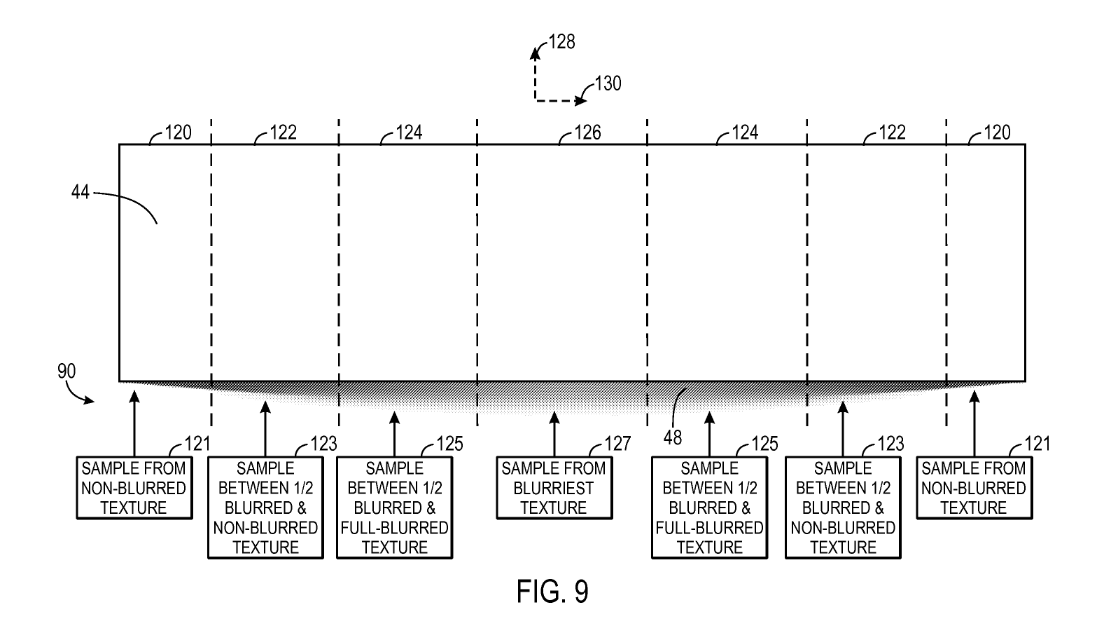

As previously discussed, the curved shadow 48 may be generated by sampling from the initial curved shadow image 72 and the blurred shadow images 76,78, as illustrated in an embodiment in FIG. 9. In this embodiment, the curved shadow 48 is generated along an outward (or downward with respect to the plane of the page) defined curve 70 such that the object 44 with which the curved shadow 48 is associated appears to be curved upward with respect to an underlying virtual surface. The opposite visual effect may be achieved by sampling from the initial curved shadow image 72 and the blurred shadow images 76,78 along an inward defined curve 70 instead. As discussed herein, a mathematical formula may be used to interpolate between the initial curved shadow image 72 and the blurred shadow images 76, 78 at different points or regions on the defined curve 70, such that an accurate curved shadow 48 is generated.

In the present embodiment, in regions 120 of the defined curve 70, the mathematical formula samples (block 121) from only the initial curved shadow 72 to generate portions 120 of the curved shadow 48 where the portions 120 exhibit a darker, less dispersed texture relative to the other regions, thereby visually suggesting close proximity or contact between the object 44 and the virtual surface on which the shadow is projected. In regions 122 of the defined curve 70, the mathematical formula samples (block 123) from both the initial curved shadow 72 and partially blurred shadow image 78 to generate portions 122 of the curved shadow 48 where the portions 122 exhibit greater blur, i.e., diffusion or dispersion, than the portion in regions 120, thereby visually suggesting greater distance between the object 44 and the virtual surface on which the shadow 48 is projected. In regions 124 of the defined curve 70, the mathematical formula samples (block 125) from both the fully blurred and partially blurred shadow images 76,78 to generate portions 124 of the curved shadow 48 where the portions 124 exhibit greater blur than the portion in regions 124, thereby visually suggesting even greater distance between the object 44 and the virtual surface on which the shadow 48 is projected. In region 126 of the defined curve 70, the mathematical formula samples (block 127) from only the fully blurred shadow image 76 to generate a portion 126 of the curved shadow 48, as shown in block 127, wherein the portion 126 exhibits greater blur than any other portion of the curved shadow 48, thereby visually suggesting the greatest distance between the object 44 and the virtual surface on which the shadow 48 is projected.

As shown in this illustrated example, the defined curve 70 is sliced into vertical portions (i.e., in direction 128) such that the mathematical formula can interpolate between the initial curved shadow image 72 and the blurred shadow images 76,78 at different points of the defined curve 70 horizontally with respect to the object 44 (i.e., in direction 130). As shown in this example, the defined curve 70 is sliced into seven vertical regions. However, the defined curve 70 may be sliced into more than or less than seven vertical regions depending on various considerations, such as: the desired resolution or accuracy of the final shadow image, the number of blurred images to be employed, or, more generally, the number of mathematical ways in which the images are to be combined. The number of vertical regions may affect, and be determined based upon, desired accuracy of the curved shadow 48, available computing power, and/or desired computing time. As will be appreciated, if the curved shadow 48 is to be generated along one of the vertical lines of the object 44, such as to depict a shadow being projected to the right or left of the object 44 (as opposed to downward or upward), the defined curve 70 may instead be sliced into horizontal portions (i.e., in direction 130) such that the mathematical formula can interpolate between the images at different points along the defined curve 70 vertically with respect to the object 44 (i.e., in direction 128).

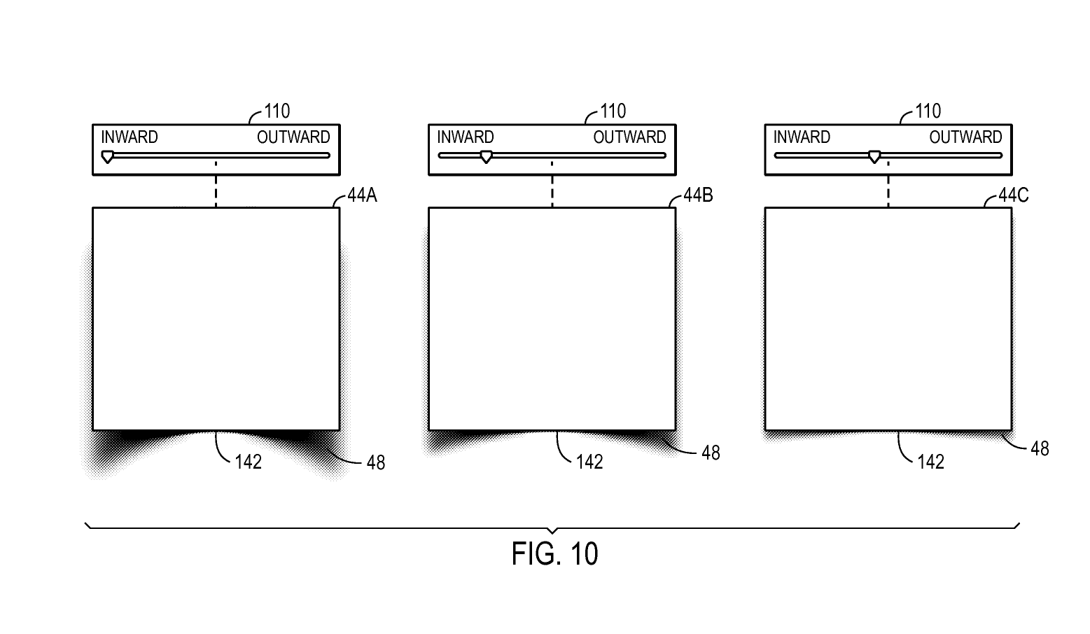

As previously discussed, an embodiment of the present disclosure may allow a user to control the extent of curvature for the inward or outward defined curve 70 or curved surface, as shown in FIG. 10. This feature may have an impact on the sampling, or interpolation, of the initial curved shadow 72 and the blurred shadow images 76,78 as discussed above, to generate the curved shadow 48. For example, a defined curve 70 with a high degree of inward curvature, as shown in the object 44A of FIG. 10, may yield a blurrier curved shadow 48 at points along the defined curve 70 having the appearance of being further away from the center 142 of the object 44A than a defined curve 70 with a low degree of inward curvature (e.g., with respect to object 44C). In general, the degree of blurriness at various points along the curved shadow 48 will be determined or governed by the mathematics defining the curve 70. However, in certain implementations the degree of blur imparted to the blurred shadow images 76, 78 may also be adjusted to impact the blurriness at different locations on the final curved shadow 48.

Continuing with FIG. 10, a user may define the curvature of an inward or outward curve via curve control sliders 110. As shown by the curve control sliders 110 of objects 44A, 44B, and 44C, a defined curve 70 with a higher inward curvature may result in a curved shadow 48 that appears to extend farther away from the object 44 and is substantially more blurred away from the center line 142 than a defined curve 70 with a lower inward curvature. As discussed with respect to previous examples, the embodiments of FIG. 10 may also apply to outward defined curves 70. However, with an outward defined curve 70, the variations in blurriness may be evident close to the center line 142 of the object 44, as the object 44 may be closer to the defined curve 70 away from the center line 142 and farther from the defined curve 70 close to the center line 142.

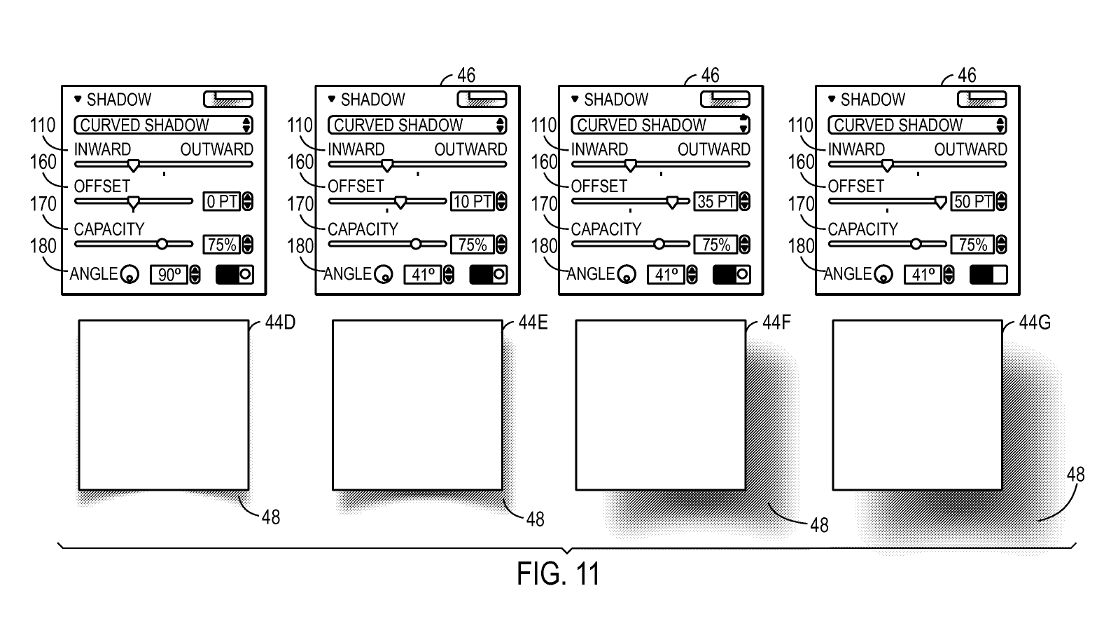

Another feature of the curved shadow 48 is illustrated in FIG. 11, in accordance with an embodiment of the present disclosure. In one embodiment, the curved shadow 48 may be generated such that the object 44 has the appearance of being in contact with the defined curve 70 on which the curved shadow 48 is projected. In other embodiments, the object 44 may have the appearance of being separated from (i.e., offset from) the defined curve 70, as specified by a user operation of an offset control slider 160 (or other suitable offset control structure). The offset may be increased or decreased to vary the apparent separation of the object 44 from the defined curve 70 where the curved shadow 48 is projected. The offset may affect characteristics of the curved shadow 48 such as blurriness and location, with increased blur typically associated with increased offset. For example, object 44G has a defined offset of greater magnitude than that of object 44E, which results in greater blur of the associated curved shadow 48 and helps determine the placement of the curved shadow 48 when displayed with the object 44. That is, greater offset may be implemented as the curved shadow 48 appearing blurrier and more off center with respect to the initial object 44 to provide the appearance of greater separation of the object 44 from the defined curve 70 via the defined offset.

In accordance with one embodiment, the control window 46 may include other features along with the previously discussed offset control slider 160 and curve control slider 110. For example, the control window 46 may include an opacity control slider 170 and a perspective control feature 180. The opacity control slider 170 may allow the user to further increase or decrease the transparency of the curved shadow 48 as desired. The perspective control feature 180 may allow the user to control the perceived orientation of a virtual light source associated with the curved shadow 48 with respect to the object 44. In other words, the perspective control feature 180 may allow the user to locate the virtual light source at a desired angle with respect to the object 44 and/or the virtual surface associated with the defined curve 70.

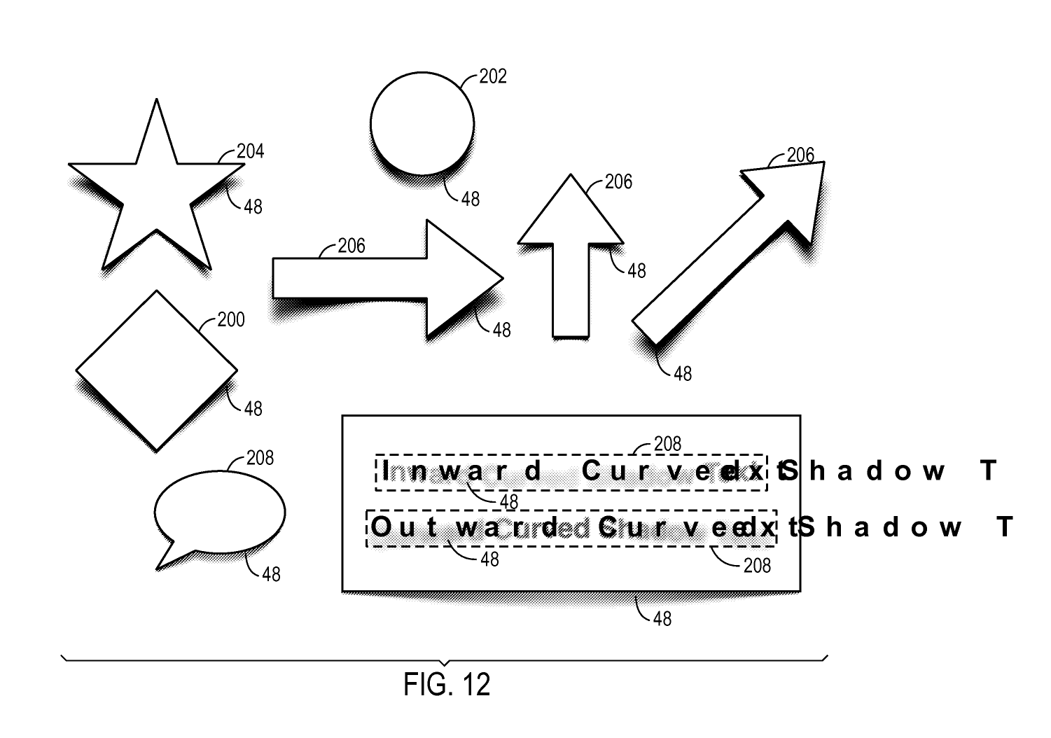

It should be noted that the present disclosure may apply to a number of different geometries for the object 44, as shown in a number of examples depicted in FIG. 12. For example, the object 44 may be a square, a diamond 200, a circle 202, a star 204, an arrow 206, a speech bubble 208, or text 208, or any other suitable image or shape object. As discussed herein, the curved shadow 48 may be inward or outward, or a combination of the two at different points or regions, and it may be oriented along any portion or location of the object 44. As will be appreciated from these examples, as well as from the other examples herein, the curved shadows 48 as discussed herein provide an appearance of depth in an otherwise planar display by creating the appearance of a shadow for an object 44 being projected onto an inward or outward curving virtual surface. Thus, an object 44 may appear to be bowed up at the edges or at the center based upon the apparent curvature of the shadows 48. Further, the use of offset and perspective, as discussed herein, further enhances the appearance of depth with respect to the displayed objects and shadows.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method performed by a processor for generating a simulated shadow of a digital object image on a virtual curved surface of a computer-implemented application having a presentation slide, comprising:
generating a base shadow image by removing color from the digital object image;
based on the virtual curved surface, generating an initial curved shadow image by projecting the base shadow image onto the virtual curved surface;
generating at least a blurred curved shadow image and a partially blurred curved shadow image by differentially blurring the initial curved shadow image; and
generating the simulated shadow on the virtual curved surface by sampling, at different points on the virtual curved surface, from one or more of the initial curved shadow image, the blurred curved shadow image, or the partially blurred curved shadow image.

2. The method of claim 1, wherein the partially blurred curved shadow image is blurred to half the extent as that of the blurred curved shadow image.

3. The method of claim 1, wherein the virtual curved surface is defined by a user.

4. The method of claim 1, wherein a mathematical formula is used to carry out the sampling between the two or more of the initial curved shadow image, the blurred curved shadow image, or the partially blurred curved shadow image.

5. The method of claim 1, wherein an offset is defined between the digital object image and the virtual curved surface.

6. The method of claim 1, wherein an opacity level is defined to vary transparency of the simulated shadow.

7. The method of claim 1, wherein a perspective is defined to locate a virtual light source such that the simulated shadow is generated on the virtual curved surface and in line with the digital object image and the virtual light source.

8. A method performed by a processor for generating a curved shadow of a digital object on a virtual curved surface of a computer-implemented application having a presentation slide, comprising:
determining a defined curve to generate the virtual curved surface;
slicing the virtual curved surface on which the curved shadow is to be applied into segments; and
sampling, at each segment, between one or more of an unblurred curved shadow image, a blurred curved shadow image, or a partially blurred curved shadow image, wherein the blurred shadow images are derived from the unblurred curved shadow image.

9. The method of claim 8, wherein the defined curve is determined by a user.

10. The method of claim 8, wherein the virtual curved surface is sliced into vertical segments with respect to the presentation slide such that the act of sampling is carried out horizontally in each respective vertical segment.

11. The method of claim 8, wherein the computer-implemented application includes a feature that allows a user to define a location for a virtual light source with respect to a location of the digital object, such that the curved shadow is generated on the virtual curved surface in line with the digital object and the virtual light source and the orientation of the slicing of the virtual curved surface into segments is determined by the location of the virtual light source with respect to the location of the digital object.

12. A method performed by a processor for generating a curved shadow of a digital object on a virtual curved surface of a computer-implemented application having a presentation slide, comprising:
generating a colorless image of the digital object;
generating an initial shadow image by projecting the colorless image on the virtual curved surface;
generating a plurality of curved blurred images by blurring the initial shadow image to different extents; and
generating the curved shadow on the computer-implemented presentation slide by slicing the virtual curved surface into segments and sampling at each segment from at least one of the initial shadow image or the plurality of curved blurred images.

13. The method of claim 12, wherein the plurality of curved blurred images comprises at least one blurred image and partially blurred image, wherein the partially blurred image is blurred to half the extent as that of the blurred image.

14. The method of claim 12, wherein the computer-implemented application includes a control window for manipulating characteristics of the curved shadow.

15. The method of claim 14, wherein the characteristics include opacity level of the curved shadow, curvature of the virtual curved surface on which the curved shadow is generated, perspective of a virtual light source defining a location of the curved shadow with respect to a location of the digital object, or a combination of one or more of these.

16. A system, comprising:
an electronic device, comprising:
one or more processors configured to execute computer readable instructions on a non-transitory, machine-readable medium; and
a presentation application, executed by at least one of the one or more processors, configured to:
determine a virtual curved surface;
slice the virtual curved surface, on which a curved shadow of a digital object is to be applied, into rectangular regions; and
sample, at each rectangular region, between one or more of a plurality of curved blurred images to generate the curved shadow, wherein each of the plurality of curved blurred images is derived from a colorless curved version of the digital object.

17. The system of claim 16, wherein the presentation application includes a control window configured to allow a user to control characteristics of the curved shadow.

18. The system of claim 17, wherein the control window is configured to include a locator for the curved shadow that locates the curved shadow with respect to the digital object, an opacity slider that varies the transparency of the curved shadow, a curvature slider that varies the extent and direction of the virtual curved surface, or a combination of one or more of these.

19. The system of claim 18, wherein the locator for the curved shadow determines the orientation of the rectangular regions sliced from the virtual curved surface.

20. The system of claim 16, wherein sampling between the two or more of the plurality of curved blurred images is executed by a mathematical formula.

21. The system of claim 20, wherein the mathematical formula is a quadratic formula, a cubic formula, or a parabolic formula.

22. A non-transitory, tangible computer-readable medium encoding processor-executable routines, wherein the routines, when executed by a processor cause acts to be performed comprising:
generating a base image by removing color from a digital object;
determining a virtual curved surface and generate an initial curved shadow image by projecting the base image onto the virtual curved surface;
generating at least a blurred curved shadow image and a partially blurred curved shadow image by differentially blurring the initial curved shadow image; and
generating a simulated curved shadow on the virtual curved surface by performing an interpolation, at different points on the virtual curved surface, using some or all of the initial curved shadow image, the blurred curved shadow image, and the partially blurred curved shadow image.

23. The non-transitory, tangible computer-readable medium of claim 22, wherein the routines, when executed by the processor, cause further acts to be performed comprising slicing the virtual curved surface into a plurality of segments such that the interpolation is carried out in each of the plurality of segments.

24. The non-transitory, tangible computer-readable medium of claim 22, wherein the virtual curved surface is determined by a user defined curve accepted by the machine readable medium.

25. The non-transitory, tangible computer-readable medium of claim 22, wherein color is removed via an alpha shader from the digital object to generate the base image

26. non-transitory, tangible computer-readable medium of claim 22, wherein an offset may be determined by the machine-readable medium such that the digital object is offset a distance from the virtual curved surface.
